(19) United States
(12) Patent Application Publication
(10) Pub. No.: US 2009/0136675 A1
(43) Pub. Date: May 28, 2009

(54) LIGHT RETRO REFLECTING FORMULATION

(75) Inventors: Carina Maria LIND, Stavsnas (SE); Svante Gustaf Sturesson Lind, Stavsnas (SE); Tomas Christer Gawalewics, Vasterhaninge (SE); Ulf Peter Sjodin, Vallentuna (SE); Per Rydberg, Enebyberg (SE)

Correspondence Address: YOUNG & THOMPSON, 209 Madison Street, Suite 500, ALEXANDRIA, VA, 22314, US

(73) Assignee: 4I AB, Stavsnas (SE)

(21) Appl. No.: 11/968,877

(22) Filed: Jan. 3, 2008

(30) Foreign Application Priority Data
Nov. 26, 2007 (SE) 0702605-7

(51) Int. Cl. B05D 1/02; C09D 189/00

(52) U.S. Cl. 427/427; 106/157.7; 106/153.1

(57) ABSTRACT

Light retro reflective, liquid formulation comprising glue and spherical glass particles (2), which glass particles (2) constitute at least 2 percentages by weight of the final formulation, and which glass particles (2) have a diameter of between 5 and 100 μm.

The invention is characterized in that the formulation also comprises at least 0.2 percentages by weight of an impregnating agent.

The present invention relates to a light reflecting, liquid formulation. More specifically, the invention relates to such a formulation intended for coating surfaces in order to produce retro reflectivity.

Retro reflective arrangements are common, for example as markings for use after dark, such as reflective tags or luminous bands adapted for being hung in the clothes of persons that are active outdoors in trafficked environments during the dark hours of day. Such retro reflective arrangements can for example be hung using a thread, or be designed to be flexible, so as to be fastened with no need of an additional fastening means. There are also retro reflective arrangements that are sewn in place as a part of a garment. Other examples of when retro reflective arrangements are used include on pets and signs.

One problem with detachable retro reflective arrangements is that it is easy to forget to put them on when being outdoors during the dark hours. Since they are clearly visible also when not reflecting incident light, they are often removed from clothing during daylight hours or when indoors. Sewn-on retro reflective arrangements are only usable on one particular piece of garment, and can make the garment less attractive. Furthermore, in many cases it is difficult to attach retro reflective arrangement on pets, baby carriages and other things that desirably should be supplied with retro reflectivity when outdoors after nightfall in trafficked environments.

It has been proposed to apply a liquid formulation containing small glass particles onto surfaces, so as to obtain reflectivity on such surfaces. By way of example, such a formulation is disclosed in the U.S. Pat. No. 3,099,637. Therein, a

The present invention relates to a light reflecting, liquid formulation. More specifically, the invention relates to such a formulation intended for coating surfaces in order to produce retro reflectivity.

Retro reflective arrangements are common, for example as markings for use after dark, such as reflective tags or luminous bands adapted for being hung in the clothes of persons that are active outdoors in trafficked environments during the dark hours of day. Such retro reflective arrangements can for example be hung using a thread, or be designed to be flexible, so as to be fastened with no need of an additional fastening means. There are also retro reflective arrangements that are sewn in place as a part of a garment. Other examples of when retro reflective arrangements are used include on pets and signs.

One problem with detachable retro reflective arrangements is that it is easy to forget to put them on when being outdoors during the dark hours. Since they are clearly visible also when not reflecting incident light, they are often removed from clothing during daylight hours or when indoors. Sewn-on retro reflective arrangements are only usable on one particular piece of garment, and can make the garment less attractive. Furthermore, in many cases it is difficult to attach retro reflective arrangement on pets, baby carriages and other things that desirably should be supplied with retro reflectivity when outdoors after nightfall in trafficked environments.

It has been proposed to apply a liquid formulation containing small glass particles onto surfaces, so as to obtain reflectivity on such surfaces. By way of example, such a formulation is disclosed in the U.S. Pat. No. 3,099,637. Therein, a formulation is described, comprising glass micro spheres, intended to be sprayed upon a surface which desirably should be given a retro reflectivity treatment.

Typically, such formulations contain, except for glass particles, also glue for attaching the glass particles to the surface. Such formulations entail the advantage that their influence on the aesthetical appearance in normal daylight of for example a textile surface is limited. On the other hand, they have proven to be associated with difficulty regarding attachment. In other words, the glass particles tend to come loose from the surface during use, whereby the retro reflective effect decreases or ceases.

The present invention solves the above described problems.

Thus, the invention relates to a light retro reflective, liquid formulation comprising glue and spherical glass particles, which glass particles constitute at least 2 percentages by weight of the final formulation, and which glass particles have a diameter of between 5 and 100 μm, and is characterized in that the formulation also comprises at least 0.2 percentages by weight of an impregnating agent.

In the following, the invention will be described in detail, with reference to exemplifying embodiments of the invention and to the appended drawings, where:

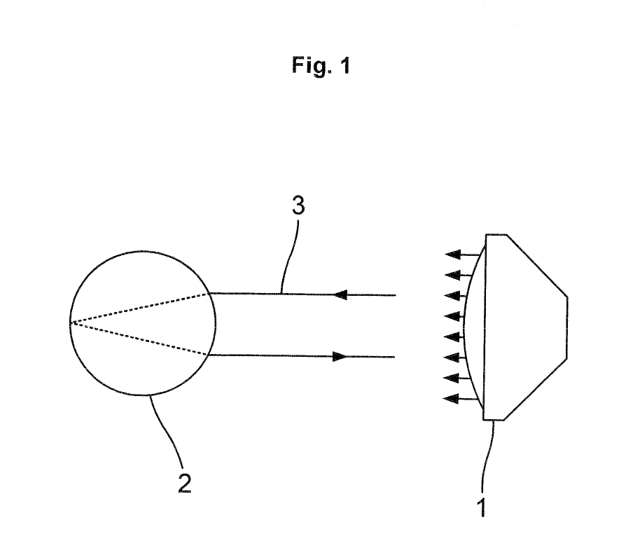

FIG. 1 is a cross sectional overview of a spherical glass particle according to the present invention.

As incident light 3 from a light source 1 strikes a small, spherical glass particle 2, a large portion of the incident light 3 is reflected back towards the light source 1. This is illustrated in FIG. 1 using solid lines, representing the light path through the air, and using dotted lines, representing the light path through the glass particle 2. Such reflection takes place over a broad spectrum of angles of incidence for the incident light 3 towards the glass particle 2, making a material whose surface is covered by such glass particles retro reflective from a broad spectrum of viewing angles.

A plurality of such small, spherical glass particles 2 are mixed together with a glue. According to a preferred embodiment, the glass particles 2 are of the type retro reflective glass beads, preferably of the type highly retro reflective glass beads. Preferably, they are manufactured from fused and consequently congealed silica glass, in other words from a so called “fused silica glass”.

The refractive index of the glass particles 2 is preferably between about 1.5 and 1.9. Their sizes may vary, but the glass particles 2 may be of essentially the same diameter or their diameters may vary. According to a preferred embodiment, the diameters are between 5 and 100 μm.

According to an especially preferred embodiment, the diameters of the glass particles are between 30 and 50 μm, and the distribution of particle sizes is such that only a small fraction of the particles, preferably fewer than 10%, have a diameter of less than 30 μm or more than 50 μm. It is especially preferred that the average diameter of the glass particles is about 37 μm, and that the spread of sizes is as small as possible. In this case, the spread of sizes should at least not be greater than that described above.

The glue is preferably constituted of a silane based binder agent whose polymerization is catalyzed by the moisture of the surrounding air. Such a binder agent can, for example, be obtained from NuSil Technology, CA, USA.

According to a preferred embodiment, the glass particles constitute at least 2 percentages by weight, preferably between 5 and 20 percentages by weight, of the final mixture, and the glue constitutes between 0.2 and 0.8 percentages by weight of the final mixture.

According to the invention, an impregnating agent is also added to the mixture. Preferred such impregnating agents are based on silicone or fluorocarbons, and examples of useful such agents comprise the impregnating agent “2202A”, marketed by Dow Corning, Michigan, USA. According to a preferred embodiment, the impregnating agent constitutes between 0.2 and 8 percentage by weight of the final mixture.

According to one embodiment, the final formulation is loaded into a conventional spray bottle together with a propellant gas. The propellant gas may be any suitable, conventional propellant gas, such as a mixture of propane and butane.

Thereafter, the formulation is applied, by spraying, onto a surface which is to be retro reflection treated. The surface may be any surface which it is desirable to render retro reflective to light, such as textile and other surfaces on clothing, footwear, furred parts of pets, baby carriages, bicycles, permanent or temporary road markings, signs, etc., or license plates on vehicles.

According to another embodiment, the final formulation is prepared in form of a mousse or a cream, in a manner which is conventional per se. In this case, the mixture is spread onto a surface such as has been exemplified above, not by spraying but rather by application of the mousse or cream.

During application, the spherical glass particles are distributed over the surface at hand. By means of the glue, they are attached to the structure of the surface.

The smallness of the glass particles makes them invisible by the naked eye. Moreover, the smallness of each single glass particle, in combination with the great number of glass particles in the formulation, lets the retro reflective contribution of each single glass particle, together with contributions from neighbouring glass particles, create the effect to the human eye of a single, coherent retro reflectivity over the whole treated surface.

Surprisingly, the use of impregnating agent in the above described proportions in the formulation has proven to substantially improve the adherence of the glass particles to the surface as compared to formulations not containing any impregnating agent in the above stated percentages. This is essential, since defective adherence earlier has been a big problem. The present invention thus achieves a substantially better abrasive resistance, and therefore ameliorates the useful life of the retro reflective effect of treated surfaces.

Also, the achieved retro reflectivity per applied glass particle has been proven to substantially increase when impregnating agent is used according to the present invention.

Furthermore, the formulation according to the present invention does not materially affect the quality of the surface with respect to its aesthetical appearance in normal daylight. This means that the surface is essentially not retro reflective in daylight, but also that its other characteristics are essentially maintained after application of the formulation of the invention. For example, this is true regarding surface characteristics such as lustre, color, surface structure, flexibility, and so on.

The formulation according to the present invention may be applied to various types of surfaces in order to make the surface retro reflective. As mentioned above, many types of surfaces may be made retro reflective by the use of a formulation according to the present invention. The retro reflective characteristics may also, as described above, be maintained during a long time without substantial deterioration.

One preferred use of a formulation according to the present invention is on pieces of garments and on footwear. The surfaces of such articles may be constituted of natural or synthetic materials, examples of such materials comprise textile, hide or leather, and plastic.

Another preferred use of a formulation according to the present invention is on the fur of a pet. In other words, a formulation according to the present invention may be applied onto for example the sides of a dog or a horse, so that the animal is more clearly visible when moving about in trafficked environments at night.

An additional use involves the application of a layer of a formulation according to the present invention onto a road marking, to render the marking more clearly visible during the dark hours. Examples of such markings comprise signs of various types, as well as various painted markings such as the lines marking the borders of different traffic lanes, etc. In this case, the use aims at giving the road marking an essentially permanent retro reflective treatment.

Such an essentially permanent retro reflective treatment is also the aim of another use, namely the use of a formulation according to the present invention for retro reflective treatment of the license plate of a vehicle, such as a car of a motorcycle.

The present invention achieves retro reflectivity without the need for separate reflective tags, luminous bands or other arrangements intended for being put on and removed depending on the time of day, etc. Furthermore, the present invention achieves a retro reflective treatment not affecting the aesthetical characteristics of a treated surface in normal daylight, and which, on the one hand, has an ameliorated abrasive resistance when using for example a retro reflective treated piece of clothing, and, on the other hand, gives a better light reflection than conventional retro reflective coatings containing glass spheres.

Above, preferred embodiments have been described. However, it will be apparent for the person skilled in the arts that many improvements may be made to the described embodiments without departing from the idea of invention. Thus, the invention shall not be limited by the described embodiments, but is capable of being varied within the scope of the accompanying claims.

1. Light retro reflective, liquid formulation comprising glue and spherical glass particles (2), which glass particles (2) constitute at least 2 percentages by weight of the final formulation, and which glass particles (2) have a diameter of between 5 and 100 μm, characterized in that the formulation also comprises at least 0.2 percentages by weight of an impregnating agent.

2. Formulation according to claim 1, characterized in that the glass particles (2) constitute between 5 and 20 percentages by weight of the final formulation.

3. Formulation according to claim 1, characterized in that the glass particles (2) have a diameter of between 30 and 50 μm, and in that the spread of sizes between different glass particles is so small so that only a small fraction of the glass particles have a diameter which falls outside of this interval.

4. Formulation according to claim 1, characterized in that the glue is a silane based glue.

5. Formulation according to claim 1, characterized in that the glass particles (2) are manufactured from glass of so called “fused silica” type.

6. Formulation according to claim 1, characterized in that the impregnating agent is constituted of a silicone- or fluorocarbon based impregnating agent.

7. Method of using a light retro reflective, liquid formulation according to claim 1 on a surface, characterized in that the formulation is applied onto the surface by spraying.

8. Method of using a light retro reflective, liquid formulation according to claim 1 on a surface, characterized in that the formulation is in the form of a mousse or a cream, and is applied directly to the surface.

9. Method according to claim 7, characterized in that the formulation is applied onto the surface so that the surface becomes light retro reflective.

10. Method according to claim 7, characterized in that the surface is a surface of a piece of garment or footwear, which surface is of natural or synthetic material, such as textile, hide or leather, or plastic.

11. Method according to claim 7, characterized in that the surface is the fur of a pet.

12. Method according to claim 7, characterized in that the surface is the surface of a road marking, in the form of a sign, a painted marking in a traffic lane or the corresponding, and in that the use aims at giving the marking a permanent retro reflective treatment.

13. Method according to claim 7, characterized in that the surface is a license plate of a vehicle, and in that the use aims at giving the plate a permanent retro reflective treatment.

14. Formulation according to claim 2, characterized in that the glass particles (2) have a diameter of between 30 and 50 μm, and in that the spread of sizes between different glass particles is so small so that only a small fraction of the glass particles have a diameter which falls outside of this interval.
